(19) United States
(12) Patent Application Publication
(10) Pub. No.: US 2005/0052349 A1
(43) Pub. Date: Mar. 10, 2005

(54) Computer systems having programmable electrochromic display segments and methods thereof

(75) Inventors: Joseph Kuczynski, Rochester, MN (US); Sophia S. Lau, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/645,743

(22) Filed: Aug. 21, 2003

(51) Int. Cl. G09G 3/19

(52) U.S. Cl. 345/49

(57) ABSTRACT

A computer-implemented system, method, and computer product for altering color attributes of electrochromic display segments of a computer system enclosure responsive to selection one or more of preselected parameters.

### BACKGROUND OF THE INVENTION

The present invention relates generally to systems and processes that are operable for selective electrical control of electro-optic media. More particularly, it relates to electrochromic display segments for use in combination with computer systems, processes, and computer program products, whereby color attributes of the segments are altered responsive to selection of different programmable parameters.

Electro-optic materials change color when subjected to electrical charges. Many are emissive, such as light emitting diodes. When subjected to electrical fields they become active and act as visual indicators. Light emitting diodes suffer from the fact that because they are active devices they require substantial power for their operation. In addition, a light emitting diode covers only a few square millimeters and thus, may not be visible when the device is placed in certain positions. In addition, it is difficult, if not impossible, to fabricate light emitting diode displays in a manner which renders them easily distinguishable under bright ambient illumination. A light emitting diode could be used as a visual indicator, but draws power continuously, thus reducing the operating time of the device, and is only visible over a limited range of orientations. Some displays, such as liquid crystal displays, are not emissive in that they do not generate their own light. They also suffer from disadvantages in that they are operative only over a limited temperature range, and have substantially no memory within the liquid crystal material. Further, the visibility of many liquid crystal displays decreases as the viewer moves a few degrees off the viewing axis, since they require polarizers.

Non-emissive, electrochromic materials have been developed recently, which change color when subjected to voltage changes. The changes are electrochemically induced by a change in their oxidation states responsive to the application of these voltages. As a result, their light absorption properties allow them to take on persistent, but reversible, color states without power being required to maintain the changed color attribute.

While electro-optic materials, such as liquid crystal displays, light-emitting diodes and electrochromic materials are known for changing colors responsive to the application of voltage, no prior art is known having computer systems including electrochromic materials that are programmed to change their color attributes in accordance with desired programmable parameters associated with various computer system operational modes being selected. Therefore, without the ability to selectively link display attributes of electrochromic display segments to operating modes associated with a computer system, the full potential of such systems is not fully realized.

### SUMMARY OF THE INVENTION

The present invention provides an enhanced computer method, system, and computer program product wherein one or more electrochromic display segments change their color attributes in a manner substantially without negative effect and that overcome many of the disadvantages of prior art arrangements.

In one illustrated embodiment, a computer system comprises: at least a portion of an enclosure; one or more programmable electrochromic display segments integrated with the enclosure portion; and, a programmable device responsive to one or more preselected parameters being selected for altering color attributes of the one or more of the electrochromic display segments. In an illustrated embodiment, the preselected parameters are selected by means of a user interface associated with the computer system. Also, the present invention has the one or more electrochromic display segments arranged in one or more visually discernible renderings, such as aesthetic patterns.

In another illustrated embodiment, the preselected parameters are selected from a computer monitored group of parameters consisting of e-mail messages, instant messages, run completion indications, computer system heating conditions, computer system power conditions, security condition messages, and, computer system aesthetics.

In another illustrated embodiment, provision is made for a method of altering color attributes of one or more electrochromic display segments of a computer system enclosure by providing one or more programmable electrochromic display segments integrated with the enclosure; and, altering color attributes of respective ones of the electrochromic display segments by a programmable device responsive to one or more preselected parameters being selected.

An aspect of the invention relates to systems and processes that are operable for selective electrical control of electro-optic media.

A still further aspect of the present invention is that it provides significant improvements over electro-optic display segments used as visual indicators, wherein the color attributes displayed are determined by different programmable parameters being selected.

An aspect of this invention is that it allows for customizing and modifying the display states of electrochromic materials in combination with a computer system based on various operating conditions of the system.

A still further aspect of the present invention is that it provides electrochromic display segments that are programmed to change their color attributes responsive to functions selected from a computer monitored group of parameters consisting of e-mail messages, instant messages, run completion indications, computer system heating conditions, computer system power conditions, security condition messages, and, computer system aesthetics.

The aspects described herein are merely a few of several that can be achieved by using the present invention. The foregoing descriptions do not suggest, however, that the invention must be used only in a manner to attain the foregoing aspects.

These and other features and aspects of the present invention will be more fully understood from the following detailed description of the preferred embodiments, which should be read in light of the accompanying drawings. It should be understood that both the foregoing generalized description and the following detailed description are exemplary, and are not restrictive of the invention.

### BRIEF DESCRIPTION OF THE DRAWINGS

FIG. 1 is a perspective schematic of a general purpose computer system according to one preferred embodiment of the present invention illustrating multiple electrochromic display segments for use in a data processing system.

FIG. 2 is a block diagram of a computer system usable in connection with the system of the present invention.

FIG. 3 is a schematic cross-sectional view of one preferred electrochromic display segment mounted on an enclosure of a computer system.

FIG. 4 is a schematic cross-sectional view of another preferred electrochromic display segment mounted on an enclosure of a computer system.

FIG. 5 is a flow diagram illustrating one aspect of the present invention.

### DETAILED DESCRIPTION

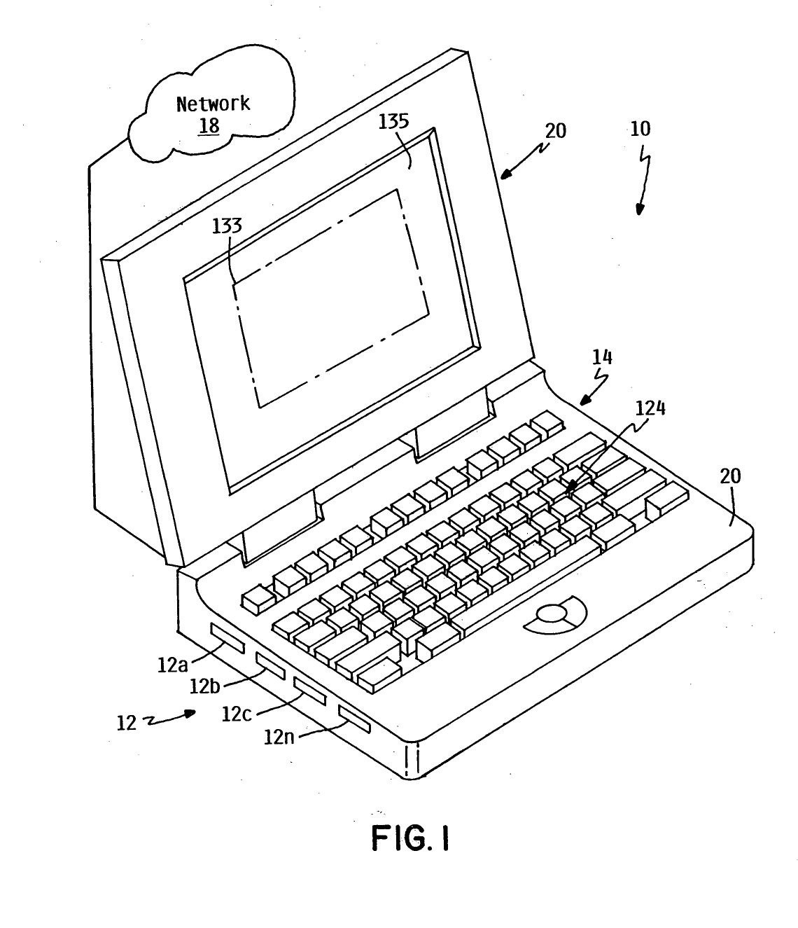

Reference is made to FIGS. 1-5 for illustrating several of the preferred embodiments of the present invention that are directed to a programmable electronic system 10, such as a computer system 10 using one or more programmable electrochromic display elements 12, segments 12. The electrochromic display segments 12 are used in combination with the computer system 10 so that their color attributes change in response to different system operating states of the computer system. Preferably, the electrochromic display segments are arranged in one or more visually discernable patterns for enhancing computer system aesthetics, communications, or the like.

Electrochromism is an electrochemically induced, persistent, but reversible, color change produced by a redox process wherein the color represents a change in the material's oxidation state. As a result, the color change will be retained without power consumption or, in limited circumstances, refreshing power. Electrochromic display segments are a solid-state type in which color attributes thereof are changed when either positively or negatively charged. Certain types of electrochromic materials, such as poly (diphenylamine) films can be reversibly changed to more than one different color when the voltage applied thereto is varied or swept through a range of values. It is to be understood that the terms electrochromic display or electrochromic display segments include all technical equivalents.

The programmable electronic system 10 may represent any type of programmable electronic device, such as computer system 10, programmable logic devices, or the like. The computer system 10 may include client computers, servers, PC-based servers, minicomputers, midrange computers, mainframe computers; portable computer systems including laptops, handheld computer systems, personal digital assistants (PDA), mobile phones, or programmable embedded processors.

FIGS. 1 & 2 illustrate the computer system 10 including a housing assembly 14 that is used in combination with the improved programmable electrochromic display segments 12a-n (collectively 12). The computer system 10 is linked to a network e-mail server through a computer network 18 in which all computer systems can receive and send e-mail messages to each other. For instance, the network 18 can be a local-area network (LAN), wide area network (WAN), the internet, or for that matter a wireless network.

In one exemplary embodiment, the computer system 10 is a laptop computer 10 commercially available from International Business Machines Corporation of Armonk, N.Y. The housing assembly 14 of the computer system laptop 10 includes a hingedly connected cover 20 and a base 22 holding a keyboard 124. Details of the laptop computer 10 are not provided herein since it is of a type that has a known construction. The electrochromic display segments 12 are, preferably, mounted on exterior surfaces of the housing assembly. Accordingly, a user can immediately discern if certain parameters have been monitored, such as e-mails from a specific person or related to a specific subject matter have been received without having to open the laptop or open an application should the display segments change color attributes.

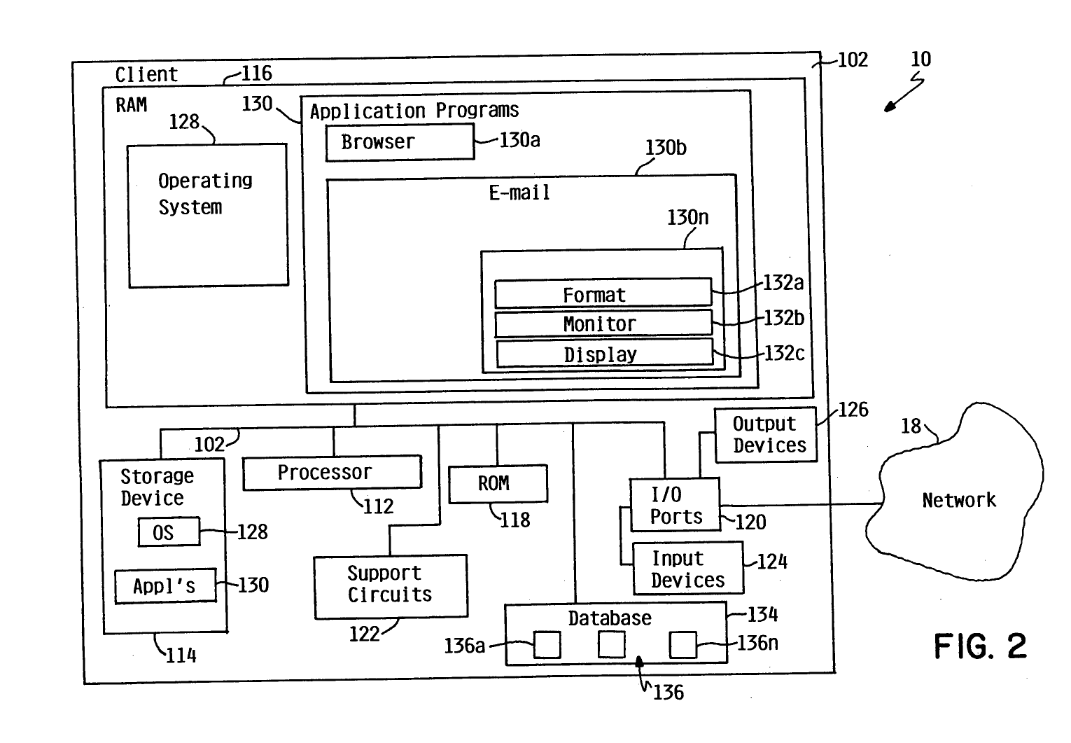

FIG. 2 illustrates the computer system 10 including an interconnect bus 102. Various components of the computer system are coupled and communicate with each other through the interconnect bus 102. Coupled to the system interconnect bus 102 is at least a single processor unit 112, a storage unit, such as a random access memory (RAM) 116, read only memory (ROM) 118, input/output ports 120 and other support circuits 122 that include controllers for the graphics display, or the like (not shown). The input and output devices 124 and 126; respectively, permit user interaction with the computer system 10. The input ports 120 can include various controllers (not shown) for each of the input devices 124, such as a keyboard 124 (FIG. 1), mouse, joystick user interface, or the like. As a result, the parameters for controlling the activation of the electrochromic display segments 12 can be selected from a computer monitored group of parameters consisting of e-mail messages, instant messages, run completion indications, computer system heating conditions, computer system power conditions, security condition messages, and, computer system aesthetics. For example, the security condition messages parameter is indicative of the computer system having been stolen, whereby a color attribute of the enclosure can be changed. The output devices 126 can include Ethernet adapter cards, infrared devices, and one or more electrochromic displays 12a-n (collectively 12) which have their color attributes changed based on the parameters that have been set by the user.

The processor unit 112 sends and receives instructions and data information to and from each of the computer systems' components that are coupled to the interconnect bus so as to perform system operations based upon the requirements of the computer system's operating system (OS) 128 and other specialized applications 130a-n (collectively referred to as application programs 130). The ROM 118 typically controls the basic hardware operations. The storage device 114 can be a permanent storage medium, such as a hard disk, CD ROM, tape, or the like which stores the operating system 128 and the specialized application programs 130. The program code of the operating system(s) and/or the applications program is sent to the RAM 116 for temporary storage and subsequent execution by the processor unit 112. The contents of the RAM 116 may be retrieved from the storage device 114 as required. Illustratively, the RAM 116 is shown with the operating system 128 and application programs 130 concurrently stored therein. The program codes of the operating system 128 and/or application programs 130, respectively, are sent to the RAM 116 for temporary storage and subsequent execution by the processor unit 112. The RAM 116 is capable of storing files from the operating system 128, as well as files from one or more application programs. Provision is made for a relational type of distributed database 134 connected to the system and under the control of the processor. A relational database management system is a computer database management system (DBMS) controlling the storing and retrieving of data to database files 136a-136n (collectively, 136) for use by the applications. The database files 136 contain detailed information of the color codes associated with the display states of each of the electrochromic display segments. Clearly, the invention envisions displaying a variety of colors having different attributes that are linked to the selected parameters. The processor unit 112 can control one of the input devices 124, which provides a user interface for allowing a user to specify run parameters relating to color attributes of the display states. The invention also contemplates having such parameters preprogrammed.

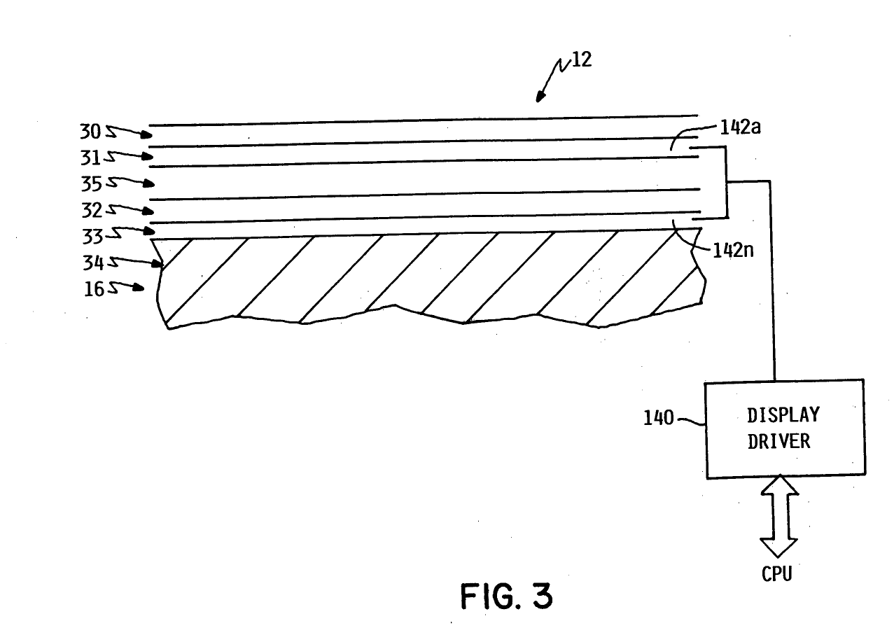

Included in the group of specialized application programs 130 is a web browser application 130a, a known type of electronic mail (e-mail) application 130b, and, a programmable electrochromic display mechanism or program 130n. The programmable display mechanism 130n and a programmable display driver 131 (FIG. 3) form a programmable device 134 that is responsive to one or more parameters being selected for altering the color attributes of the one or more electrochromic display segments. The electronic mail (e-mail) application 130b includes known functions including an event(s) receiving function, which analyzes incoming messages for particular attributes including specific e-mail senders, such as a person(s) that are programmed by the user for activating the electrochromic display segments 12. In this embodiment, once a specified message is received it is passed to the operating system whereupon it will be acted upon by an electrochromic display program 130n in a manner to be described. Illustratively, the electrochromic display program 130n includes a display option formatting module 132a, a monitoring module 132b, and a display module 132c. The modules selectively interact with each other when executed as described below and together provide desired programmable display functions that are responsive to monitored parameters selected. As noted, the parameters are programmed, but, of course, can be preprogrammed. The display option formatting module 132a generates, for example, a graphical user interface (GUI) 133 (FIG. 1) on the screen 135 of the computer to permit a user to configure and save the type of display format (e.g., alphanumeric, etc.) to be used, the color code or attributes that are to be displayed in response to a match with an activating parameter, as well as the activating parameter or group of activating parameters that are to be monitored. The monitoring module 132b provides a method for monitoring the selected parameters, whereby once monitored, the parameters function to activate the display module 132c. The display module 132c operates the programmable display driver 131 (FIG. 3) for activating the various electrochromic display segments consistent with the settings of the formatting module. Although it is desired to have the parameters selectable, such need not be the case.

The programmable display driver 131 is part of the programmable device 134 for altering the colors of the one or more electrochromic display segments 12 by providing different voltages to the one or more segments. The voltages applied to the one or more segments are in accordance with the configured parameter values set by a user using the electrochromic display mechanism 130n. Each parameter setting can have a particular color code associated with it that is tied to the particular color attribute of a particular electrochromic display segment. The display driver 131 can cooperate with a set of matrix-addressable electrodes 142a-n (collectively 142). The electrodes 142 can be connected to and form part of the electrochromic display segments 12 in a known manner; such as described below to apply adjustable voltages of the display driver to alter the color attributes and display attributes of the electrochromic display segments. The display driver 131 can be any suitable type that is operable for varying the voltage outputs to the electrochromic display segment. As a result, the color attributes of the segments are varied in response to the variable voltages applied to the segments in a known manner. Other types of display driver circuits for adjusting the electrical field are contemplated. The voltage can be suitably adjusted to the electrodes to vary the display states. The display driver 131 is also operable for use in relatively rapidly varying the voltage to the electrodes whereby the color attributes electrochromic display program 130n is relatively rapidly changed.

Reference is now made to the electrochromic display segments 12, which essentially include non-emissive, electro-optic displays made of electrochromic materials. Essentially, each of the electrochromic display segments is made from any of several known constructions. For example, the electrochromic displays can be of the solution type, the precipitation type, or the thin-film type. Clearly, the present invention envisions similar kinds of display segments that have yet to be developed.

In FIG. 3, one of the illustrated embodiments of an electrochromic display segment is illustrated. Various constructions of the electrochromic display segments are known and only those portions necessary for understanding this embodiment will be provided. Many other types of constructions are envisioned. The electrochromic display segment 12 includes a sandwiched construction essentially including, in overlying relationships, a protective/insulating layer 30, electrochromic layer(s) 32, and electrodes 142a and 142n over an enclosure or chassis cover layer 34.

The protective/insulating layer 30 can include a thin glass plate or can include optically clear polycarbonate, polyester, acrylic, or the like. The protective/insulating layer 30 possesses other properties including moisture, chemical, and scratch resistance. The protective/insulating layer 30 is generally about 1 to about 5 mils in thickness.

Coated on an interior surface of the protective/insulating layer 30 is a transparent, electrically conductive layer 31 that forms one of the electrodes 142a. The electrically conductive layer 31 is made of indium-tin-oxide (ITO) or other suitable material. Accordingly, a transparent surface for allowing viewing of the color changes is provided.

The electrochromic layer(s) 32 is comprised of a thin film coating. The thin film electrochromic layer 32 is, preferably, about 0.1 to about 5.0 μm thick, and can be comprised of suitable electrochromic materials, such as tungsten oxide, Everitt's salt, poly(pyrrole), poly (aniline) and poly(thiophene). The electrochromic layer 32 can be comprised of any of the known types of electrochromic materials that have been or are yet to be developed. Sandwiched between the electrochromic layer 32 and the electrically conductive layer 31 is a thin film electrolyte film or layer 35 that serves to enhance conductivity and provide a transparency for allowing viewing of the color changes to the electrochromic layer 32. The electrolyte film 35 is a suitable thin conductive material, preferably, made of poly (ethylene oxide) PEO with lithium salts, or any suitable solid electrolyte film having a suitable thickness. The electrochromic layer 32 includes other properties, such as providing an open-circuit memory that decreases power consumption. The electrochromic layer(s) 32 is secured adhesively to a connector or electrode layer 33 by a laminating adhesive or using suitable electrodeposition techniques, spin coating, or knife coating. Other equivalent adhesive materials can be used, such as an optically clear PSA, a suitable thermal bonding film, a UV-curable adhesive, or the like. The connector or electrode layer 33 can be an optically transparent counter or a reflective counter type of electrode. Other suitable electrodes types are envisioned. The connector or electrode layer 33 forms another electrode 142n that is coupled to the display driver for operation in a known manner to change the color attributes of the electrochromic layer.

The chassis cover layer 34 is comprised of any suitable thermoplastic and can be further comprised of PC, ABS, PC/ABS, or the like and forms a portion of an enclosure for the computer system. Other suitable materials for the chassis cover layer 34 are contemplated including insulated metal, or the like. The cover layer 34 serves to mount the electrode or connector layer 33. The chassis cover layer 34 includes other suitable properties, such as durability, shock protection, chemical and scratch resistance. The chassis cover layer 34 is generally about 1/16 inch to about ⅛ inch in thickness. The chassis cover layer 34 is secured adhesively to the electrode layer 33 by any suitable laminating film type adhesive. Other equivalent adhesive materials can be used, such as optically clear PSAs, thermal bonding films, UV-curable adhesives, or the like. The chassis cover layer 34 can be integrated in a top surface 16 of the housing assembly or can be integrated in a manner to be otherwise easily mounted and removed as by being insertable.

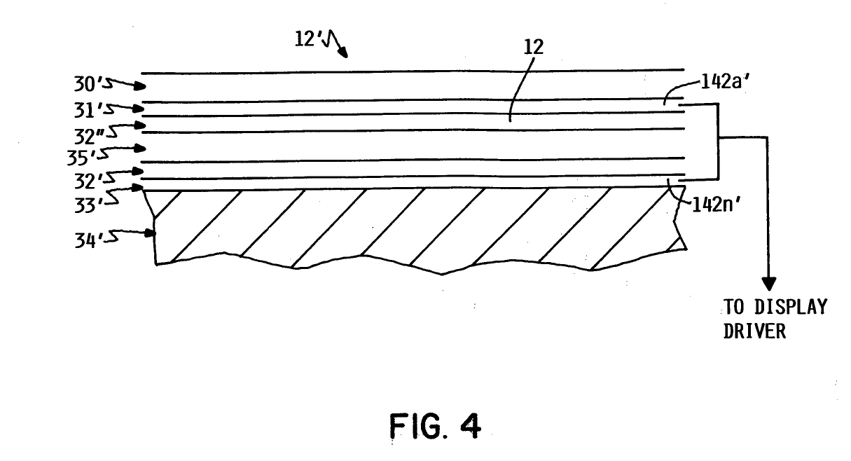

FIG. 4 depicts another exemplary preferred embodiment. It differs essentially from the preceding example by depicting multiple electrochromic layers. Accordingly, those components of this embodiment, like the former will be indicated by the same reference numeral, but with the addition of a prime marking. This embodiment differs from the proceeding in that it includes a second electrochromic layer 32″ that is superposed over the first electrochromic layer 32′. A suitable thin conductive electrolyte film 35′ is sandwiched between the two electrochromic layers 32′, 32″ for electrically coupling them together. While two electrochromic layers 32′, 32″ are depicted, it is pointed out that any suitable number can be utilized as is known.

Many electrochromic materials also possess a transparent state so a wide range of colors can be achieved by layering several electrochromic films. Electrochromism can be achieved by a wide range of materials. These materials can include but are not limited to: [a] transition metal oxides, such as WO₃, MoO₃, V₂O₅, Nb₂O₅, Ir(OH)₃ and Ni(OH)₂; [b] Prussian blue systems including Prussian brown; Prussian green and, Prussian white; [c] viologens, 1,1′-Disubstituted-4,4′-bipryridinium salts; conducting polymers, for instance, polypyrrole, polythiophene, polyaniline; [d] transition metal and lanthanide coordination complexes and metallopolymers, such as metal hydrides; [e] inorganic electrochromic materials, such as transition metal oxides; [f] organic electrochromic materials, such as viologens; and, composite electrochromic materials, such as tungsten trioxide and polyaniline composite. Alternatively, an RGB electrochromic array can also be constructed on the chassis. Alternatively, the one or more electrochromic display segments 12 can be made of other known or yet to be developed constructions that can be integrated in a permanent or releasable fashion on the housing assembly.

Clearly, the electrochromic display segments 12 can have a wide variety of different shapes and sizes. They can be formed to provide a wide variety of design renderings or patterns for aesthetic and other purposes. Their relatively thin nature enables them to conform to a wide variety of surfaces. In addition, they are lightweight. Moreover, they can be made to provide relatively large display areas. These are beneficial improvements over LEDs and LCDs. Hence, an extremely versatile visual display and indicator is provided that is especially useful on the surfaces of portable computers, or the like.

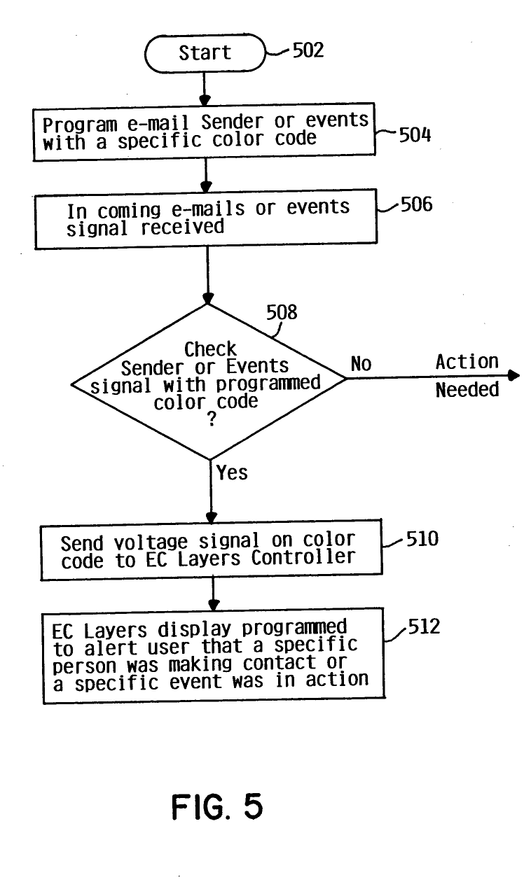

Reference is made to FIG. 5, which illustrates one of the exemplary embodiments in which the principles of the present invention are applied. The process starts at block 502 wherein a user, through a user interface, can programmably set parameters for activating the electrochromic display segments as well as the display format and color attributes to be displayed by the one or more electrochromic display segments 12 in accordance with the present invention. The activating parameter settings can include particular parameters selected from a group including e-mail senders and/or specific events (e.g. theft, power, etc.). The particular parameter is received at block 506. At block 508, the incoming parameter is checked against the listing of parameters that have been saved by the formatting module. If there is no match with the programmed parameters, then the present color attribute(s) of the electrochromic display segments 12 remains and no action is needed. If there is a match, then the particular activating parameter received is compared against the color code and the display format set by the formatting module, whereby the color attributes to be displayed are to be effected. At block 510, the voltage values needed in order to effect the desired color attributes and display format are sent to the display driver, which activates the electrochromic display segments. At block 512, the electrochromic display segments display the programmed color to alert the user that a specific person has sent an e-mail and/or that a specific event(s) has occurred.

It will be appreciated in accordance to the present invention, that the various display segments are associated with the parameters, whereby the displays or color attributes can be altered. As noted, the displays can provide selected varieties of patterns including information and/or patterns that serve as indicators. When setting the parameters, specific color attributes associated with monitored parameters are selected.

Advantages include having a method and computer system using electrochromic display segments, which change color in response to monitored events associated with the operation of the computer system. More specifically, such advantages enhance functionality and packaging aesthetics, whereby the full potential of computer systems is more fully realized.

From the foregoing description, it is clear that several advantages flow from this invention. Advantages include being able to selectively customize the aesthetics of computer system enclosures, and improving the functionalities of computer systems by preferably programmable electrochromic display segments whose color attributes are altered responsive to different programmable parameters, whereby different types and kinds of visual indications can be provided.

The embodiments and examples set forth herein were presented to best explain the present invention and its practical applications and thereby enabling those skilled in the art to make and use the invention. However, those skilled in the art will recognize that the foregoing description and examples have been presented for the purposes of illustration and example only. The description set forth is not intended to be exhaustive or to limit the invention to the precise forms disclosed. In describing the above preferred embodiments illustrated in the drawings, specific terminology has been used for the sake of clarity. However, the invention is not intended to be limited to the specific terms selected. It is to be understood that each specific term includes all technical equivalents that operate in a similar manner to accomplish a similar purpose. Many modifications and variations are possible in light of the above teachings without departing from the spirit and scope of the appended claims.

1. A programmable electronic system comprising: at least a portion of an enclosure for the system; one or more programmable electrochromic display segments integrated with the enclosure portion and each having color attributes; and, a programmable device responsive to selection of one or more preselected parameters for altering the color attributes of the selected one or more electrochromic display segments.

2. The system of claim 1 wherein the one or more electrochromic display segments is selected from a group consisting of a solution type, a precipitation type, and a thin-film type.

3. The system of claim 1 wherein the preselected parameters are selected from a computer monitored group consisting of e-mail messages, instant messages, run completion indicators, computer system heating condition indicators, computer system power conditions, security condition messages, and, computer system aesthetics.

4. A computer system comprising: at least a portion of an enclosure; one or more programmable electrochromic display segments integrated with the enclosure portion and each having color attributes; and, a programmable device responsive to selection of one or more preselected parameters for altering the color attributes of the selected one or more electrochromic display segments.

5. The computer system defined by claim 4 wherein values of the preselected parameters to be utilized are selected by means of a user interface.

6. The computer system defined by claim 4 wherein the preselected parameters are selected from a computer monitored group consisting of e-mail messages, instant messages, run completion indicators, computer system heating condition indicators, computer system power conditions, security condition messages, and, computer system aesthetics.

7. The computer system defined by claim 6 wherein the security condition messages parameter is indicative of the computer system having been stolen, whereby a color attribute of the enclosure portion is altered.

8. The computer system defined by claim 6 wherein the e-mail messages parameter include messages from preselected senders.

9. The computer system defined by claim 4 wherein the computer system is selected from a group of computer systems consisting of: PDA, PC, server, client, mainframe, laptop, mobile phone, and embedded processor.

10. The computer system defined by claim 9 wherein the computer system is a laptop computer and the electrochromic display segments are visible from exterior surface of the laptop when the laptop is in a closed condition.

11. The computer system defined by claim 4 wherein the one or more electrochromic display segments is selected from a group consisting of a solution type, a precipitation type, and a thin-film type.

12. The computer system defined by claim 4 wherein the programmable device includes a display driver that is operable to have control signals applied to the one or more electrochromic display segments.

13. An enclosure adapted for use in enclosing at least a portion of a system having a programmable device responsive to one or more monitored parameters thereof being selected for altering color attributes of one or more electrochromic display segments, the enclosure comprising: a body for enclosing at least a portion of the system, and, one or more programmable electrochromic display segments integrated with the body, the display segments are operable for altering color attributes thereof in response to selection of the one or more parameters.

14. The enclosure defined by claim 13 wherein the body of a system is selected from a group of computer systems consisting of PDA, PC, server, client, mainframe, laptop, mobile phone, and embedded processor.

15. The enclosure defined by claim 14 wherein the system is a laptop and the electrochromic display segments are mounted on an exterior surface of the laptop to be visible when the laptop is in a folded or closed condition.

16. The enclosure defined by claim 13 wherein the one or more display segments is selected from a group of electrochromic display segments consisting of a solution type, a precipitation type, and a thin-film type.

17. A method of altering color attributes of one or more electrochromic display segments of an enclosure portion of programmable electronic system, the method includes providing an enclosure with one or more programmable electrochromic display segments integrated therewith; and, altering color attributes of one or more of the electrochromic display segments responsive to selection of the one or more parameters of a programmable device of the system.

18. The method defined by claim 17 wherein the selection of preselected parameters is through a user interface of the programmable electronic system.

19. The method defined by claim 17 wherein the preselected parameters are selected from a computer monitored group consisting of e-mail messages, instant messages, run completion indicators, computer system heating condition indicators, computer system power conditions, security condition messages, and, computer system aesthetics.

20. The method defined by claim 19 wherein the security condition messages parameter is indicative of the system having been stolen, whereby a color attribute of the enclosure portion is altered.

21. The method defined by claim 18 wherein the e-mail messages include messages from preselected senders.

22. The method defined by claim 17 wherein the system is selected from a group of computer systems consisting of PDA, PC, server, client, mainframe, laptop, mobile phone, and embedded processor.

23. The method defined by claim 22 wherein the computer system is a laptop and the electrochromic display segments are visible from an exterior surface of the laptop when the laptop is in a closed condition.

24. The method defined by claim 17 wherein the one or more display segments is selected from a group of electrochromic display segments consisting of a solution type, a precipitation type, and a thin-film type.

25. The method defined by claim 17 wherein the programmable device includes a display driver that is operable to control signals applied to the one or more electrochromic display segments.

26. A computer-implemented method for controlling electrochromic display segments integrated with an enclosure of a computer system, the method comprising the steps of: programmably setting one or more parameter values each associated with a computer system function and each for use in activating one or more electrochromic display segments; monitoring for an occurrence of the one or more set parameter values; and, selecting one or more electrochromic display segments for activation in response to the monitored occurrence.

27. The method of claim 26 wherein a user sets the one or more parameter values through a user interface.

28. The method of claim 27 wherein a user sets the one or more parameter values through a graphical user interface.

29. A computer system comprising: an enclosure portion; one or more electrochromic display segments integrated with the enclosure portion, each of which is operable for changing color attributes thereof for visually altering the enclosure portion color; the system comprising:
a memory containing a programmable application that accepts user input for configuring one or more parameter values, monitors for an occurrence of the one or more configured parameter values, and, activates one or more of the electrochromic display segments in response to the monitored occurrence; and,
a processor operably coupled to the memory which performs operations, comprising: allowing a user to programmably set one or more parameter values each of which is associated with a computer system function, and each of which is for use in activating one or more electrochromic display segments; monitoring for one or more of the set parameter values; and, activating one or more electrochromic display segments in response to the monitored occurrence of one or more set parameters values to change the color attributes of the enclosure.

30. The system of claim 29 wherein the parameter values are selected from a computer monitored group consisting of e-mail messages, instant messages, run completion, computer system heating conditions, computer system power, and security conditions messages, and computer system aesthetics.

31. A computer program product for facilitating altering of color attributes of one or more electrochromic display segments of a computer system enclosure portion, the computer program product comprising:
a medium readable by a computer, the computer readable medium having a computer program code to alter color attributes of the one or more electrochromic display segments responsive to the monitored occurrence of one or more programmably set parameter values.

32. The computer program product of claim 31 wherein the parameter values are selected from a computer monitored group consisting of e-mail messages, instant messages, run completion indicators, computer system heating condition indicators, computer system power conditions, security condition messages, and, computer system aesthetics.
